(19) United States
(12) Patent Application Publication
(10) Pub. No.: US 2016/0114429 A1
(43) Pub. Date: Apr. 28, 2016

(54) DISSIMILAR METAL JOINED BODY

(71) Applicant: PANASONIC INTELLECTUAL PROPERTY MANAGEMENT CO., LTD., Osaka (JP)

(72) Inventors: DAISUKE SHIOGA, Fukui (JP); TOMOMI TANAKA, Hyogo (JP); KOJI FUNAMI, Kyoto (JP)

(21) Appl. No.: 14/888,446

(22) PCT Filed: Apr. 7, 2015
(86) PCT No.: PCT/JP2015/001939

§ 371 Date: Nov. 2, 2015

(30) Foreign Application Priority Data
Apr. 15, 2014 (JP) 2014-083277
Feb. 17, 2015 (JP) 2015-028157

(51) Int. Cl. B23K 26/323; B23K 26/00

(52) U.S. Cl. CPC B23K 26/323; B23K 26/0006; B23K 2203/18

(57) ABSTRACT

A dissimilar metal joined body includes a copper material, an aluminum material and a molten mixed portion. The molten mixed portion is configured so that part of the aluminum material is melted and flows into the copper material. The depth from a surface of the copper material which contacts the aluminum material in the molten mixed portion is at least 5 μm and no greater than 30 μm.

### TECHNICAL FIELD

The present invention relates to a dissimilar metal joined body formed by joining a copper-based material (hereinafter, a copper material) and an aluminum-based material (hereinafter, an aluminum material) by laser welding.

### BACKGROUND ART

Generally, a hard and brittle intermetallic compound is formed in a molten portion in the laser welding between dissimilar metals. Accordingly, the joint strength is largely reduced as compared with a case of welding between same kinds of metals and brittle fracture behavior is shown. As an example of practical use of the joined body of the copper material and the aluminum material, a joined body having the following structure is known.

(1) A joined body having an insert structure using a clad material of the copper material and the aluminum material

The joined body is fabricated in the following manner. A clad material including a first metal member and a second metal member is arranged between a first metal and a second metal which are materials to be welded and have different melting points so that the same kind of metals contact each other. In this state, the first metal, the clad material and the second metal are integrated by laser welding from both surfaces of the first metal and the second metal in a welding condition in which dissimilar metals do not melt each other (for example, refer to Patent Literature 1).

(2) A joined body having a spot-laser welding structure

The joined body is fabricated in the following manner. A first metal plate and a second metal plate having different melting points are partially overlapped. The overlapped portions are irradiated with laser discontinuously, thereby forming spot-like welding portions continuously (for example, refer to Patent Literature 2).

### CITATION LIST

### Patent Literature

PTL 1: JP-A-4-081288

PTL 2: WO2006-016441

### SUMMARY

The present disclosure provides a dissimilar metal joined body of a copper material and an aluminum material the joint strength of which is increased to a base material strength.

A dissimilar metal joined body according to the present invention includes a copper material, an aluminum material and a molten mixed portion. The molten mixed portion is configured so that part of the aluminum material is melted and flows into the copper material. A depth from a surface of the copper material which contacts the aluminum material in the molten mixed portion is at least 5 μm and no greater than 30 μm.

In the combination of the copper material and the aluminum material, a hard and brittle metal compound is easily deposited. However, it is possible to increase the joint strength to the level in which fracture occurs in a base material part of the aluminum material having relatively low mechanical strength in the dissimilar metal joined body formed of the copper material and the aluminum material.

### BRIEF DESCRIPTION OF DRAWINGS

FIG. 1 is a view schematically showing a cross section of a joined portion according to the embodiment of the present invention.

FIG. 2 is a graph showing the relation between the input energy mount and the peel strength/the dimension of the molten mixed portion according to the embodiment of the present invention.

### DESCRIPTION OF EMBODIMENTS

Prior to the explanation of embodiments of the present invention, problems in a related-art apparatus will be briefly explained. In the joined body in Patent Literature 1, the clad material is necessary. A physical space for sandwiching the clad material is also necessary. Furthermore, it is necessary to emit laser beam from front and back both sides of the welding materials to be welded. Therefore, the performance of the structure to be joined may be deteriorated, and it may be difficult to join the materials due to structural constraints.

For example, when the joined body in Patent Literature 1 is applied to a joint of a plate material (bus bar) connecting between cell electrodes in an in-vehicle battery module, the volume or mass is increased as a whole as the clad material is interposed between the bus bar and the cell electrode. Accordingly, the energy density as an important performance of the battery module is reduced. Furthermore, it is necessary to consider variations in thickness of the clad material in the laser welding in which the highly-precise positioning is necessary in the optical axis direction, which complicates production process.

A cell main body is arranged just below a contact part of the bus bar and the cell electrode to be joined. Therefore, the cell main body blocks the access of the laser beam to reverse faces of the bus bar and the cell electrode. Therefore, it is difficult to emit the laser beam from the reverse faces of the bus bar and the cell electrode.

The joined body in the Patent Literature 2 is characterized by suppressing alloying which causes increase of an electric resistance value by forming the spot-like welding portions by pulse waves not by forming a linear welding portion by continuous irradiation of the laser beam. Therefore, the joint area is inevitably reduced and it is difficult to improve the joint strength to the base material strength.

Hereinafter, an embodiment of the present invention will be explained with reference to the drawings.

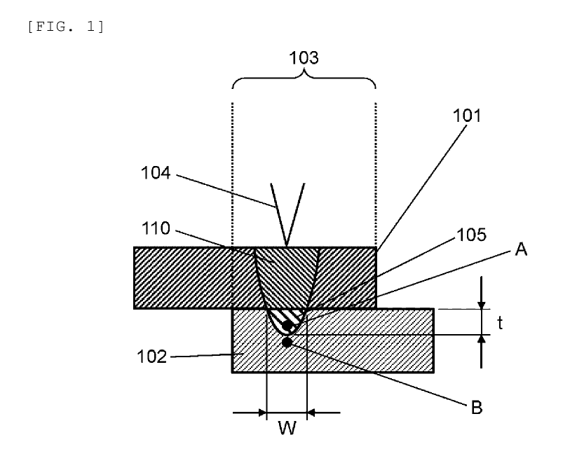

FIG. 1 is a view schematically showing a cross section of a joined portion according to the embodiment of the present invention.

An aluminum material 101 and a copper material 102 which are members to be joined are partially overlapped to thereby form an overlapping area 103 and welded by irradiating an arbitrary position in the overlapping area 103 with a laser beam 104. The laser beam 104 is emitted continuously from a surface of the aluminum material 101 having a relatively low melting point, which is the opposite side of a surface contacting the copper material 102, thereby forming a linear welding portion. Accordingly, a molten mixed portion 105 which is continuous in a scanning direction as well as having a width W and a depth “t” of a certain specific range is formed. The width W indicates the shortest dimension of the molten mixed portion 105 on a surface of the copper material 102 which contacts the aluminum material 101.

The aluminum material 101 irradiated with the laser beam is melted completely to the surface contacting the copper material 102 at the moment when the laser beam 104 is emitted. Therefore, a molten portion 110 connecting to the molten mixed portion 105 is formed in the surface of the aluminum material 110, which is opposite to the surface contacting the copper material 102.

The molten mixed portion 105 is formed so that the aluminum is melted and flows into the copper material 102 from the surface of the aluminum material 101 which contacts the copper material 102. The surface contacting the copper material 102 indicates the reverse surface of the aluminum material 101, which is opposite to the surface irradiated with the laser light 104. Various parameters such as the output, scanning speed and the energy density of the laser beam 104 are optimized so that the molten mixed portion 105 is formed. Then, the shape dimension of the molten mixed portion 105 determines the joint strength of the joined body.

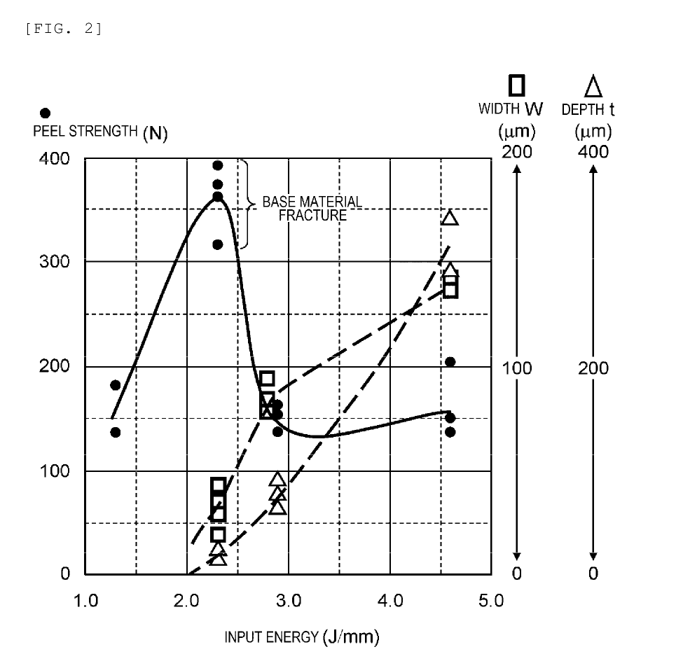

As an example of the embodiment, FIG. 2 shows the relation of the peel strength of the joint of the joined body, the width W and the depth “t” of the molten mixed portion 105 with respect to the input energy value when performing welding by using a fiber laser having higher light condensing performance in a range in which the laser output is 500 to 1100 W and the scanning speed is 240 to 720 mm/s.

When the molten mixed portion 105 is formed to have the same shape dimension, the necessary input energy value is changed according to the thickness of the aluminum material 101 irradiated with the laser beam 104. Therefore, the optimum value depending on the thickness of the aluminum material 101 exists in the input energy values in which the high joint strength can be obtained.

In the case where the same kind of materials are joined, the joining strength is increased in proportion to the input energy amount. On the other hand, in the case where dissimilar materials are joined, the molten mixed amount is increased as the input energy amount is increased. Accordingly, the joint strength is extremely reduced as the deposition of an intermetallic compound is increased. FIG. 2 shows results obtained when the thickness of the aluminum material 101 is 0.6 mm as an example.

According to the results shown in FIG. 2, in the case where the thickness of the aluminum material 101 is 0.6 mm, the peel strength is 320 to 400 N when the input energy value is approximately 2.3 J/mm, and the base material is fractured when peeled. Accordingly, it is found that the joint strength of the joined portion has been improved to the base material strength level. The peel strength is the same level as the same metal joined body of aluminum materials. It has been checked that the same tendency is shown when the thickness of the copper material 102 is at least 1 mm and/or when the thickness of the aluminum material 101 is at least 0.5 mm and no greater than 0.8 mm.

The depth “t” of the molten mixed portion 105 in which the high joint strength as described above can be obtained is limited to a certain specific range. Specifically, the range of at least 5 μm and no greater than 30 μm is preferable. The width W is preferably limited to a range of at least 10 μm and no greater than 50 μ.

The optimum range of the above width W is 20% to 30% of the case where the same materials are joined. Accordingly, the width W of the molten mixed portion 105, namely, the welding width can be narrowed. The input energy amount is extremely reduced as compared with the case where the same materials are welded as described above, thereby forming the molten mixed portion 105 as the welded portion to be thinner and shallower. Accordingly, the number of welding lines can be multiplied to three or four times. In this case, the joint strength can be further improved while maintaining the ductility performance.

It has been checked that the concentration of a copper component inside of the molten mixed portion 105, for example, at a place A is suppressed to be lower than 10%. On the other hand, it is checked that the concentration of an aluminum component in a region near the molten mixed portion 105 in the copper material 102, for example, at a place B is also suppressed to be lower than 10%. It is preferable that the deposition of the intermetallic compound is suppressed to a small amount as described above. It can be considered that brittle fracture behavior does not occur and a ductility fracture mode is obtained as the deposition of the intermetallic compound is suppressed to a small amount (plastic deformation of the base material appears).

It is preferable that the surface of the copper material 102 is covered with Ni plating. Specifically, it has been checked that the copper material 102 covered with Ni plating is partially overlapped with the aluminum material 101 and irradiated and welded with the laser beam 104 as described above to thereby forma stronger joint.

The dissimilar metal joined body according to the embodiment includes the copper material 102, the aluminum material 101 and the molten mixed portion 105. The molten mixed portion 105 is configured so that part of the aluminum material 101 is melted and flows into the copper material 102. The depth from the surface of the copper material 102 contacting the aluminum material 101 in the molten mixed portion 105 is at least 5 μm and no greater than 30 μm. According to the configuration, it is possible to increase the joint strength to the level in which fracture occurs in the base material part of the aluminum material 101 which has relatively low mechanical strength.

### INDUSTRIAL APPLICABILITY

The dissimilar metal joined body according to the present invention can be applied to the connection between the bus bar connecting between terminals of a battery and an individual electrode terminal. Especially in the in-vehicle secondary battery and so on, an expensive clad-material bus bar formed of the copper material and the aluminum material is used for connecting between electrode terminals, and the structure formed of only the joined body of the same kind of materials is adopted. However, it is possible to connect between any terminals only by the inexpensive aluminum material by the dissimilar joined body according to the present invention. Accordingly, great economic effects can be expected.

### REFERENCE SIGNS LIST

101 aluminum material

102 copper material

103 overlapping area

104 laser beam

105 molten mixed portion

110 molten portion

1. A dissimilar metal joined body comprising:
a copper material;
an aluminum material; and
a molten mixed portion containing the copper material into which part of the aluminum material is melted,
wherein a depth from a surface of the copper material which contacts the aluminum material in the molten mixed portion is at least 5 μm and no greater than 30 μm.

2. The dissimilar metal joined body according to claim 1,
wherein a shortest dimension of the molten mixed portion is at least 10 μm and no greater than 50 μm on the surface of the copper material which contacts the aluminum material.

3. The dissimilar metal joined body according to claim 1,
wherein a molten portion connecting to the molten mixed portion is formed in a surface of the aluminum material, which is opposite to a surface contacting the copper material.

4. The dissimilar metal joined body according to claim 1,
wherein a concentration of a copper component inside the molten mixed portion is lower than 10% and a concentration of an aluminum component in a vicinity of the molten mixed portion in the copper material is lower than 10%.

5. The dissimilar metal joined body according to claim 1,
wherein a thickness of the copper material is at least 1 mm.

6. The dissimilar metal joined body according to claim 1,
wherein a thickness of the aluminum material is at least 0.5 mm and no greater than 0.8 mm.

7. The dissimilar metal joined body according to claim 1,
wherein the copper material is covered with Ni plating.

8. The dissimilar metal joined body according to claim 1,
wherein the dissimilar metal joined body is configured as a terminal connection in an in-vehicle secondary battery.

9. A method for forming a dissimilar metal joined body comprising:
overlapping an aluminum material and a copper material to form an overlapping area; and
irradiating the aluminum material in the overlapping area with a laser beam to form a molten mixed portion containing the copper material into which part of the aluminum material is melted;
wherein a depth from a surface of the copper material which contacts the aluminum material in the molten mixed portion is at least 5 μm and no greater than 30 μm.

10. The method according to claim 9,
wherein the molten mixed portion is formed to have a shortest dimension of at least 10 μm and no greater than 50 μm on the surface of the copper material which contacts the aluminum material.

11. The method according to claim 9, further comprising:
forming a molten portion connecting to the molten mixed portion in a surface of the aluminum material which is opposite to a surface contacting the copper material.

12. The method according to claim 9, further comprising:
providing a concentration of a copper component inside the molten mixed portion to be lower than 10%; and
providing a concentration of an aluminum component in a vicinity of the molten mixed portion in the copper material to be lower than 10%.

13. The method according to claim 9, further comprising:
providing a thickness of the copper material to be at least 1 mm.

14. The method according to claim 9, further comprising:
providing a thickness of the aluminum material to be at least 0.5 mm and no greater than 0.8 mm.

15. The method according to claim 9, further comprising:
covering the copper material with Ni plating.

16. The method according to claim 9, further comprising:
configuring the dissimilar metal joined body as a terminal connection in an in-vehicle secondary battery.
